(19) United States
(12) Patent Application Publication
(10) Pub. No.: US 2011/0007917 A1
(43) Pub. Date: Jan. 13, 2011

(54) Two Chip Solution Band Filtering

(75) Inventor: Gibson D. Elliot, Oak Run, CA (US)

Correspondence Address: The TPL Group;C/O Alliacense Limited LLC, 20883 Stevens Creek Boulevard, Suite 100, Cupertino, CA, 95014, US

(73) Assignee: SWAT/ACR PORTFOLIO LLC, Cupertino, CA (US)

(21) Appl. No.: 12/500,484

(22) Filed: Jul. 9, 2009

(51) Int. Cl. H04R 25/00

(52) U.S. Cl. 381/317

(57) ABSTRACT

A behind the ear earpiece 205 capable of multiband filtering with multiple core processors incorporated on a miniature solid state chip. The apparatus includes a plurality of microphones 305a-n and a plurality of pre-amplifiers 310a-n, an analog to digital converter 320, a digital signal processor 325 and a digital to analog converter 335 all hidden behind the ear of a user 215 with a battery. All are connected to a speaker 325 attached for producing an acoustic signal to the user 215. The method of the invention provides a compact multiband filter using a plurality of processors 405 connected to one another with single drop busses 410. Groups 415, 420, 425, 430, 435, 440, 445 and 450 520, 530, 535, 545 of processors are assigned to each particular band and each group performs multiple multiply-accumulate (“MAC”) calculations 520, 530, 535 and 545. Each MAC 520, 530, 535 and 545 is accomplished with use of the multiple registers in each core 405.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention pertains to an array of processors utilized to perform processing intensive functions. In particular, the invention pertains to methods and apparatus of implementing band filtering on an array of processors.

### BACKGROUND OF THE INVENTION

Processing devices can be utilized for a wide range of applications. For example, an electronic hearing aid includes a first processing device for converting electrical signal from a microphone into digital samples. A second processing device processes the digital samples to amplify or attenuate the particular frequencies where a user suffers hearing loss. A third processing device converts the processed digital samples into electrical signals used at a speaker for producing sound.

In prior art systems the signal processing in a hearing aid is largely dependent on the amount of processing available to the hearing aid. Cheaper analog hearing aids perform simple amplification of the input signal. More expensive digital hearing aids perform greater signal processing than amplification of the input signal. People who suffer from hearing loss gain by using a hearing aid because even small amounts of signal processing will provide some measure of improved hearing. However, the degree to which hearing is improved can be related to the cost of the hearing aid. Existing hearing aids that encompass hearing improvement devices can range from several hundred to several thousand dollars. Consumer reports suggest that hearing improvement devices, such as those on the lower end of the cost spectrum, provide little to no hearing improvement because these devices simply amplify the input signal and do not address the root causes of hearing loss. While not perfect, more expensive hearing aids address several of the root causes of hearing loss in a package that performs a significant amount of signal processing. The processors performing the signal processing are not cheap and also incur significant power consumption.

Thus, there exists a need for a digital hearing aid that can provide a high level of signal processing without posing limitations of significant power consumption, size requirements, and speed requirements, plus providing a hearing improvement unit that sells at a retail price in line with what a person with some measure of hearing loss can afford.

### SUMMARY OF THE INVENTION

The invention provides a behind the ear earpiece which is capable of multiband filtering with low power consumption and small size. This is possible by utilization if multiple core processors incorporated on a miniature solid state chip. The result is an extremely competent behind the ear hearing aid of unprecedented effectiveness combined with robustness.

The apparatus includes a plurality of microphones and a plurality of pre-amplifiers, an analog to digital converter (“ADC”), a digital signal processor and a digital to analog converter (“DAC”) all easily hidden behind the ear with a battery. All are connected to a speaker attached for producing an acoustic signal to the user.

The method of the invention provides a compact multiband filter utilizing a multicore process with high power yet low power consumption. Groups of processors are assigned to each particular band and each group performs multiple multiply accumulate (“MAC”) calculations. Each MAC is accomplished with use of the multiple registers in each core.

### BRIEF DESCRIPTION OF THE FIGURES

FIG. 1 is a block diagram behind the ear, earpiece according to a first exemplary embodiment of the invention;

FIG. 2 is a top plan view of the physical components of an embodiment of the invention in a working environment;

FIG. 3 is a block diagram of the apparatus of another embodiment of the invention;

FIG. 4 is a diagram of an array of processing devices performing the band processing component of the behind the ear, earpiece;

FIG. 5 is a flow chart describing the method used by the first of four processing devices in a grouping of processing devices for the purpose of performing band filtering for a particular frequency range; and

FIG. 5a is a flow chart describing the methodology for performing the calculation of a generalized MAC step as part of the band filtering process.

### DETAILED DESCRIPTION OF THE INVENTION

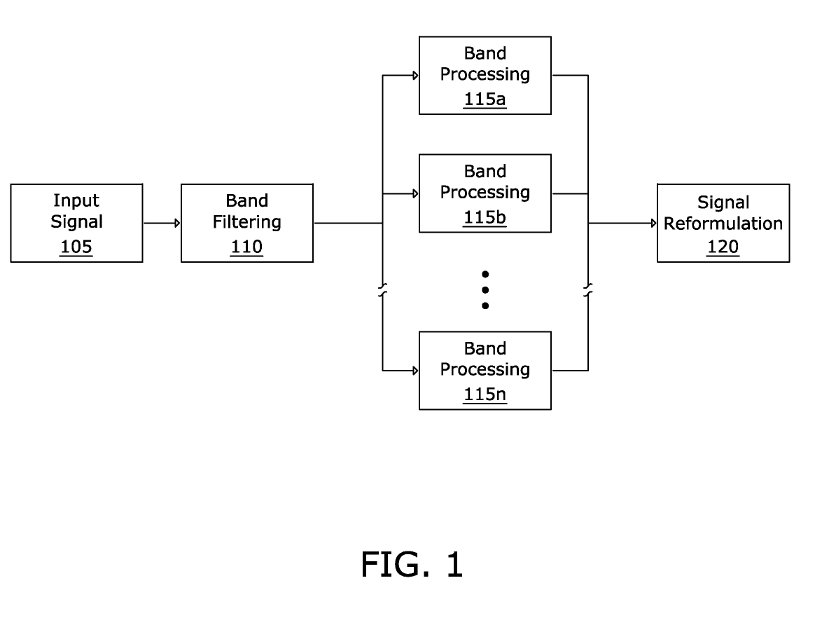

FIG. 1 is a functional block diagram of a signal processing device that performs the function of band separation, band processing, followed by signal reconstruction in a first exemplary embodiment of the invention. The functional blocks described hereinbelow should be understood to represent general functions and not their actual circuit layout and arrangement. An input signal block 105 generates or samples a generated signal to produce an input signal to the rest of the system. The output from signal block 105 is sent via a data and control path (herein referred to as path) to a band filtering block 110. The band filtering block performs the function of separating the input signal into predefined frequency ranges. Output from band filtering block 110 along a plurality of paths is to band processing blocks 115a through 115n. The band processing blocks 115a through 115n will perform any number of functions to the separated band frequency data. According to one embodiment, a lowpass filter relative to the frequency range of the data could be applied to the data for smoothness. Output from the band processing blocks 115a through 115n along a path is to a band reformulation block 120.

With band filtering block 110, the input signal is divided according to predefined frequency ranges. In a preferred embodiment, the band filtering in block 110 is a recursive filter. Recursive filters are performed functionally by combining input signal values and the previously calculated values of the output signal. A predetermined number of coefficients are assigned to the input signal values and the previously calculated values of the output signal. Next a convolution algorithm is performed whereby the particular coefficients assigned to the input signal multiply the input signal values and the particular coefficients assigned to the output signal multiply the output signal values and the products are summed to produce a new output signal value.

Recursive filters, also known as infinite impulse response (“IIR”) filters, are extremely useful because they are much faster than typical finite impulse response (“FIR”) as they bypass a larger convolution calculation. The recursive filter equation shown next shows a sum of products whereby coefficients a₁ to aₙ are defined for the input signal values and coefficients b₁ to bₙ are defined for the output signal values.

yₙ=a₀·xₙ+a₁·xₙ₋₁+a₂·xₙ₋₂+a₃·xₙ₋₃+a₄·xₙ₋₄+ . . . +b₁·yₙ₋₁+b₂·yₙ₋₂+b₃·yₙ₋₃+b₄·yₙ₋₄+ . . .

Recursive filters convolve the input signal with a very long filter kernel although only a few coefficients are involved. A recursive filter can be performed with no limit to the number of calculation coefficients, however, in typical applications only a couple of coefficients are used for the input and output signal.

A typical application of a recursive filter is in band filtering. An example of a recursive filter that performs band filtering is a Chebyshev filter. For example, a Chebyshev filter could be used to separate the lower frequencies, upper frequencies, or even both upper and lower frequencies. Unlike a windowed-sinc filter function, a Chebyshev filter is several orders of magnitude faster and is carried out by recursion, not convolution. Chebyshev filters are designed as an optimal tradeoff between ripple and roll-off. Note that it is possible for ripple in both the passband and stopband, however Chebyshev filters have ripple only in the stopband.

The order of a Chebyshev filter, like any other IIR filter, determines the number of sum of products and sums. An n^{th} order filter yields 2n+1 product and sums. Recall from the recursive filter equation that there is always one more coefficient for the input signal than for the output signal. For example, a second order Chebyshev filter utilizes five coefficients, where three coefficients are for associated with the input signal and two are associated with the output signal. Five products and sums are performed to produce a new output. The order of a Chebyshev filter can also refer to the number of times an order n filter is repeated. For example, two second order Chebyshev filters performed sequentially produce a fourth order Chebyshev filter.

The coefficients for such a calculation are pre-determined based on well known in the art computations for formulating the calculations coefficients. Once the calculation coefficients have been determined based on the order of the filter among other factors, the calculation begins.

Recursive filters convolve the input signal with a very long filter kernel although only a few coefficients are involved. While a recursive filter can be performed with no limit to the number of coefficients, a typical recursive filters utilizes fewer coefficients due to the fact that IIR filters, like the name implies, are infinitely long in their impulse response.

An approximation to the Chebyshev filter equation is based on a recursive filter equation whose sum of products is shown in an approximation to the recursive filter equation.

yₙ=B₀·f(xᵢ)+A₁·yₙ₋₁−A₂·yₙ₋₂

The values B₀, A₁, and A₂ are coefficients derived for the approximation to the recursive filter equation and are based on the order of the Chebyshev filter. The functional inputs to the approximation to the recursive filter equation f(xᵢ) are based on the various type of filter response that is desired. If a bandpass type of response is desired, then the functional inputs to the approximation to the recursive filter equation f(xᵢ) are defined in a bandpass functional input equation.

f(xᵢ)=x−x₂

If a lowpass type of response is desired, then the functional inputs to the approximation to the recursive filter equation f(xᵢ) are defined in a first lowpass functional input equation.

f(xᵢ)=x+2x₁+x₂

In a second embodiment, if a lowpass type of response is desired the functional inputs to the approximation to the recursive filter f(xᵢ) are defined in a second lowpass functional input equation.

f(xᵢ)=0.5x+x₁+0.5x₂

If a highpass type of response is desired, the functional inputs to the approximation to the recursive filter equation f(xᵢ) are defined in a highpass functional input equation.

f(xᵢ)=x−2x₁+x₂

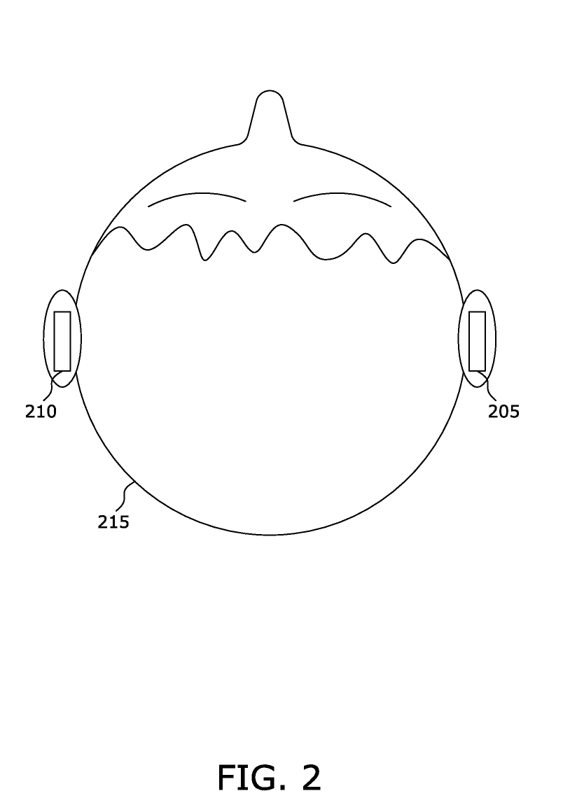

FIG. 2 is a top plan diagram of the physical components of a hearing aid system embodying the invention that includes a right behind the ear, earpiece 205, a left behind the ear, earpiece 210. The hearing aid system is operable to reproduce processed sound to the cochlea of the inner ear in a manner that amplifies or attenuates the particular frequencies where a user 215 suffers hearing loss.

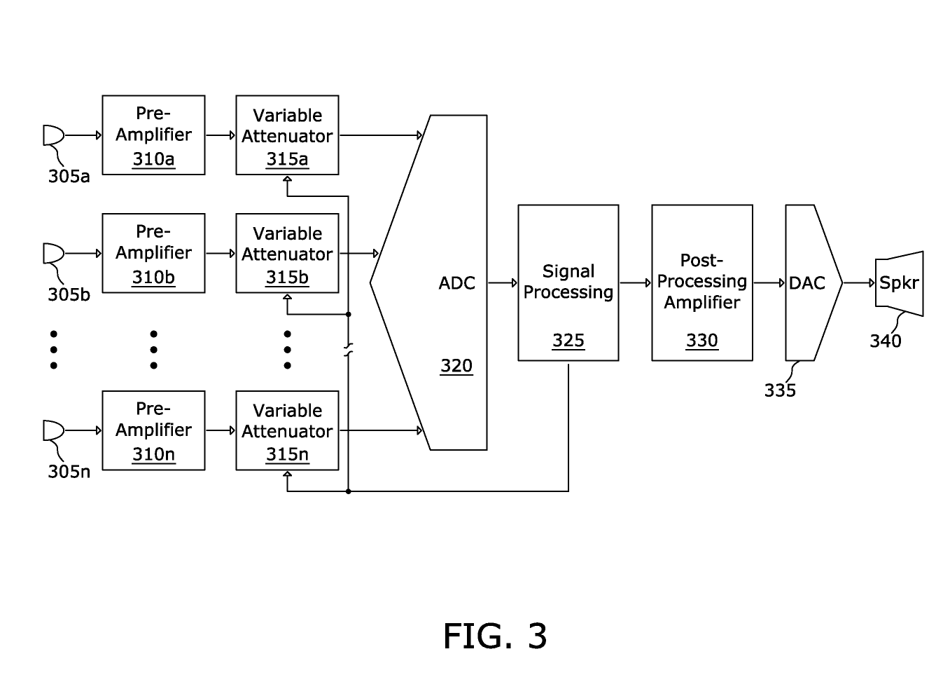

FIG. 3 is a functional block diagram of a behind the ear, earpiece (herein referred to in short as earpiece) embodying the invention, earpiece according to a first exemplary embodiment of the invention. The functional blocks described hereinbelow should be understood to represent signal processing functions performed by the earpiece in general, and not its actual circuit layout and arrangement. The earpiece includes a plurality of microphones 305a through 305n that are connected by means of a plurality of data and control paths (herein referred to in short as path or paths) to a plurality of pre-amplifiers 315a through 315n. The plurality of microphones 305a through 305n are operable as transducers to produce an electrical signal proportional to a received acoustic signal. The plurality of preamplifiers may include a series of suitably matched amplifiers used in conjunction with the microphone for increasing the amplitude of the electrical analog signal. Output from the plurality of preamplifiers 315a through 315n is connected by means of a plurality of paths to a plurality of variable attenuators 320a through 320n. The plurality of variable attenuators is operable for matching the sensitivity of the plurality of microphones 305a through 305n. Output from the plurality of variable attenuators 320a through 320n is connected by means of paths to an analog to digital converter (“ADC”) 325 operable to convert the electrical analog signal received from the variable attenuators 320a through 320n into a discrete digital signal. Output from the ADC 325 is connected by a path to a signal processing unit 330 operable to perform the functions of a directional microphone, band processing filter, and signal reconstruction unit. The directional microphone is operable to combine the digitized audio samples based on the physical direction from which the intensity of the audio is greatest. The band processing separates the audio samples based on predefined frequency ranges from approximately 20 Hz to 20 KHz. Also as a part of band processing, a distinct analytic magnitude divider (“AMD”) associated with each band provides dynamic compression, attenuating signals of amplitude greater than a threshold value and amplifying signals below said threshold. The threshold value and compression ratio of each AMD is predetermined to the hearing loss profile of a particular user. Dynamic compression acts to reduce the dynamic range of signals received at the ear and accordingly reduces the masking effect of loud sounds. The compression algorithm of each AMD provides spectral contrast enhancement to compensate for simultaneous masking at nearby frequencies in the frequency domain and introduces inter-modulation distortion that mimics the distortion produced naturally by a healthy cochlea. An equalizer bank within the signal reconstruction unit applies a predetermined amount of gain to the output of each AMD when reformulating the signal to produce sound at the ear of the user. Output from the signal processing unit 325 is connected by a path to a post-processing amplifier 330 functional to amplify the digitized sound. Output from the post-processing amplifier 330 is connected by a path to a digital to analog converter (“DAC”) 335 operable to convert the electrical signal received from the post processing amplifier 330 into a continuous analog signal where it can be reproduced as sound at a speaker 340. Output from the signal processing unit 325 is also connected back to the variable attenuators 320a-320n.

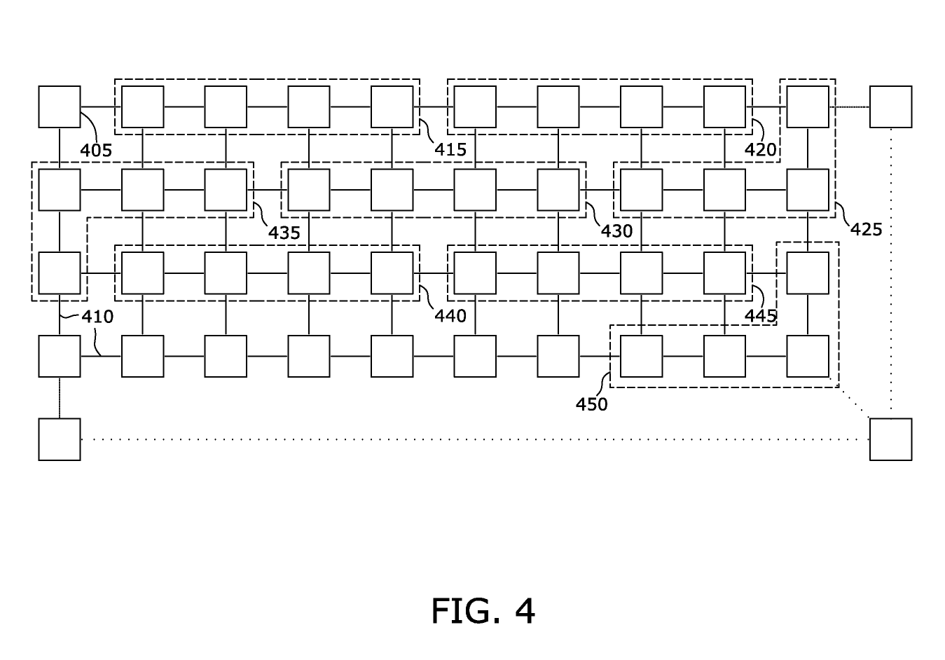

FIG. 4 is a diagram of an array of processing devices performing the band processing component of an embodiment of the behind the ear, ear piece. A plurality of processing devices 405 communicates with four neighboring processing devices over a single drop bus 410 that includes data lines, read lines, read control lines, and write control lines. There is no common bus. In an embodiment, the processing devices of FIG. 4 may be a 40 core multiprocessor array, sold under the registered trademark SEAforth® by IntellaSys® Corporation of Cupertino, Calif., a member of The TPL Group of companies, this invention is not limited to 40 core multiprocessor arrays and equally applies to microprocessor arrays with varying numbers of cores. However, for the sake of example, the following discussion references SEAforth® 40 core multiprocessor arrays.

Band processing is divided into eight components that are spread across the array of processing devices, each of which separate the audio samples into predefined frequency ranges. Four processing devices perform the function of band filtering for a particular frequency range. Band 7 is processed among a first grouping of processing devices 415. Band 0 is processed among a second grouping of processing devices 420. Band 6 is processed among a third grouping of processing devices 425. Band 5 is processed among a fourth grouping of processing devices 430. Band 4 is processed among a fifth grouping processing devices 435. Band 3 is processed among a sixth grouping of processing devices 440. Band 2 is processed among a seventh grouping of processing devices 445. Last, band 1 is processed among an eighth grouping of processing devices 450.

The processing of the bands is organized so that bands 0 to 6 perform a bandpass filter function while band 7 strictly performs a lowpass filter function. Bands 0 to 7 receive the same sample values and perform the band filtering in parallel. The samples are processed in the bands in the following order: band 7, followed by band 0, followed by band 6, followed by band 5, followed by band 4, followed by band 3, followed by band 2, and followed by band 1. The results of the band processing are also stacked and passed to the other bands in the following manner. The result from band 7 is passed to band 0, the result from band 0 along with the result from band 7 is passed to band 6. The result from band 6 along with the results from bands 0 and 7 are passed to band 5. The result from band 5 along with the results from bands 0, 7, and 6 are passed to band 4. The result from band 4 along with the results from bands 0, 7, 6, and 5 are passed to band 3. The result from band 3 along with the results from bands 0, 7, 6, 5, and 4 are passed to band 2. The result from band 2 along with the results from bands 0, 7, 6, 5, 4, and 3 are passed to band 1. The result from band 1 along with the results from bands 0, 7, 6, 5, 4, 3, and 2 are sent to the AMD unit (not shown). Due to the manner in which the results from each band are stacked at the end of the eight bands, the AMD will multiplex the appropriate value for its computation.

Within each band, a second order Chebyshev filter is performed three times sequentially totaling a sixth order Chebyshev filter. Each second order Chebyshev filter is performed by the standard sum of five products in a slightly modified way. The modified computation of the second order Chebyshev filter is divided into three categories bandpass, lowpass, and highpass.

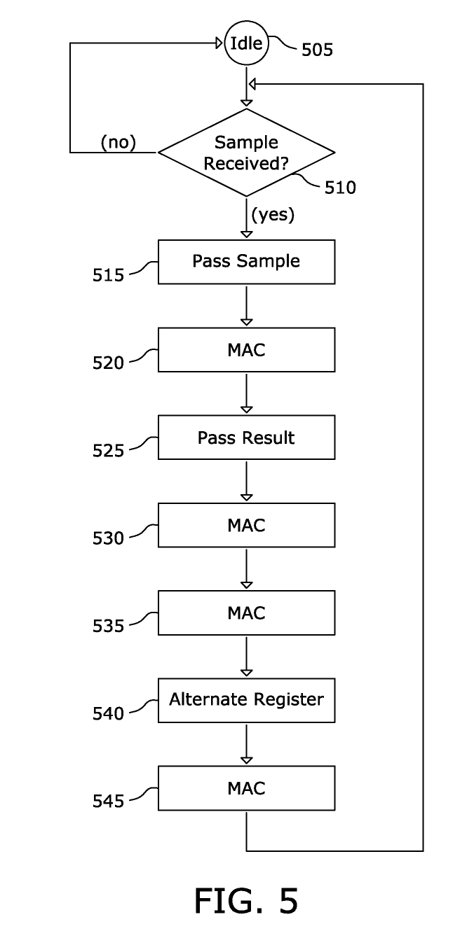

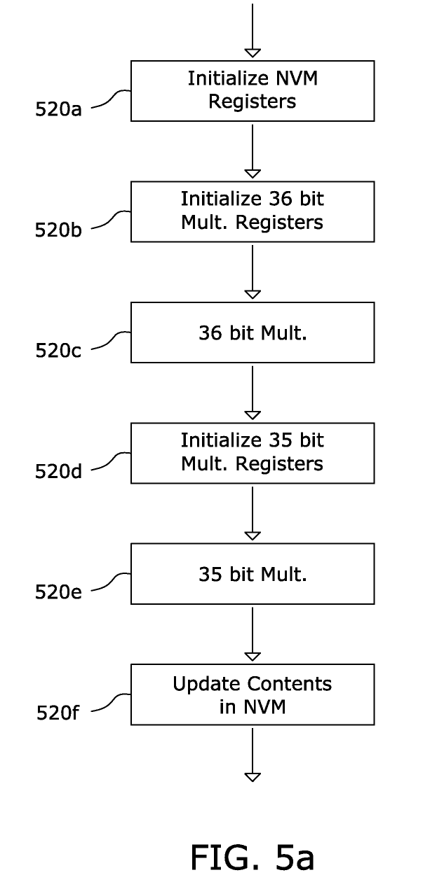

FIG. 5 is a flow chart describing an embodiment of the method of the invention used by the first of four processing devices in a grouping of processing devices for the purpose of performing band filtering for a particular frequency range. In the power up condition the state machine is in an idle state 505. In a step 510 the state machine verifies if a first sample has been received by the processing device. If a sample has been received by the processing device in a step 510, then in a step 515 the state machine passes the sample to the next processing device within the grouping of processing devices for the purpose of performing band filtering. Otherwise, the state machine refers to an idle state 505. In a step 520, a multiply-accumulate (“MAC”) calculation is performed and the details of this calculation are described in FIG. 5. In a step 525, the results from the first MAC are sent to the next processing device within the grouping of processing devices for the purpose of performing band filtering. In a step 530, a MAC calculation is performed. Next in a step 535, another MAC calculation is performed. In a step 540, an alternate register is selected in which the result from the MAC calculation is stored. A total of two registers are used for the result from the MAC calculation. What is alternated is between the first and third of four registers used for storing the results of the MAC calculation. Last, in a step 545 another MAC calculation is performed.

Within the state machine of FIG. 5 the first pass through results in three MAC calculations prior to an alternate register being selected for the result from which to store the results from the MAC calculations. Following this, a total of four MAC calculations are always performed before the alternate register is selected. Each MAC unit updates the contents of two sequential registers in the non-volatile memory (“NVM”) of the processing device in which the calculation is being performed. Each of the MAC calculations in the state machine of FIG. 5 perform the same function, but the registers within the processing device whose values are utilized in the calculation of the MAC are initialized to different values for each MAC calculation. Hence, the MAC of step 520 will herein be referenced as a first MAC, the MAC of step 530 will be herein referenced as a second MAC, the MAC of step 535 will herein be referenced as a third MAC, and the MAC of step 540 will herein be referenced as a fourth MAC.

FIG. 5a is a flowchart describing the methodology for performing the calculation of a generalized MAC step as needed in the steps 520, 530, 535, and 545 of FIG. 5. Returning to FIG. 5a, in a step 520a the two sequential registers in the NVM where the results from the MAC are stored is initialized. In a step 520b, the registers utilized for the purpose of performing a 36 bit multiplication are initialized. In a step 520c, a 36 bit multiplication is performed. Next in a step 520d, the registers utilized for the purpose of performing a 35 bit multiplication are initialized. Next in a step 520e, a 35 bit multiplication is performed. Last, in a step 520f, the two sequential registers in the NVM in the processing device in which the calculation is being performed are updated with the combined results from the 36 bit and 35 bit multiplications.

The following example references the flow chart of FIG. 5a and the methodology for a generalized MAC step. From the step 520a the two sequential registers in the NVM M(n) and M(n+1) are initialized to the value A(n) and A(n+1) respectively. From the step 520b, the T-register, S-register, and A-register are initialized to the values 0, x and y, respectively, in preparation for the 36 bit multiplication. From the step 520c, the results of the 36 bit multiplication is 0′, x, and y′ in the T-register, S-register, and A-register. From the step 520d, the T-register, S-register, and A-register are initialized to the values 0′, z, and x, respectively, in preparation for the 35 bit multiplication. From the step 520e, the results of the 35 bit multiplication is 0″, z, and x′ in the T-register, S-register, and A-register. Last, from the step 520f, the first of two sequential registers M(n) contains the value A(0)+x′ and the second of two sequential registers M(n+1) contains the value A(1)+[(0″xor z) xor z].

The first MAC in the step 520 of FIG. 5 is illustrated as follows. Returning to FIG. 5a, the step begins in a step 520a by initializing the NVM A(n) and A(n+1) to the value of 0. Next in the step 520b the T-register, S-register, and A-register are initialized to the values 0, B₀, and s, respectively. The value B₀ is one of three coefficients utilized in the Chebyshev filter. The value s is the first half of a 36 bit sample fetched from a neighbor processing device. Next in the step 520c, the 36 bit multiplication is performed and the results stored in the T-register, S-register, and A-register are 0*, B₀, and s* respectively, in preparation for the 36 bit multiplication. In the step 520d, the T-register, S-register, and A-register are initialized to the values 0*, S, and B₀ respectively, in preparation for the 35 bit multiplication. The value S is the second half of a 36 bit sample fetched from a neighbor processing device. Next in the step 520e the 35 bit multiplication is performed and the results stored in the T-register, S-register, and A-register are 0**, S, and B₀*. Last, in the step 520f, the NVM register A(n) is stored with the value A(n)+B₀* and the NVM register A(n+1) is stored with the value A(n+1)+[(0** xor S) xor S].

The second MAC in the step 530 of FIG. 5 is illustrated as follows. Returning to FIG. 5a, begins in a step 520a by initializing the NVM A(n) and A(n+1) to the value of 0. Next in the step 520b, the T-register, S-register, and A-register are initialized to the values 0, A₂, and −A(n)* respectively, in preparation for the 36 bit multiplication. The value A₂ is the second of three coefficients utilized in the Chebyshev filter. The value −A(n)* is the negation of the value stored in the NVM register A(n) after the first MAC calculation in the step 520 of FIG. 5. Returning to FIG. 5a, next in the step 520c the 36 bit multiplication is performed and the results stored in the T-register, S-register, and A-register are 0̂, A₂, and (−A(n)*)̂. In the step 520d, the T-register, S-register, and A-register are initialized to the values 0̂, −A(n+1)*, and A₂ respectively, in preparation for the 35 bit multiplication. The value −A(n+1)* is the negation of the value stored in the NVM register A(n+1) after the first MAC calculation in the step 520 of FIG. 4. Next in the step 520e, the 35 bit multiplication is performed and the results stored in the T-register, S-register, and A-register are 0\hat{̂}, −A(n)*, and A₂̂. Last in the step 520f the NVM register A(n) is stored with the value A(n)+A2̂ and the NVM register A(n+1)is stored with the value A(n+1)+[(0\hat{̂}xor −A(n+1)*) xor −A(n+1)*].

The third MAC in the step 530 of FIG. 5 is illustrated as follows. Returning to FIG. 5a, begins in a step 520a by initializing the NVM A(n) and A(n+1) to the value of A(n)** and A(n+1) ** respectively, in preparation for the 36 bit multiplication. The value A(n)** is the value stored in the NVM register A(n) after the second MAC calculation in the step 530 and the value A(n+1)** is the value stored in the NVM register A(n+1) after the second MAC calculation in the step 530. Next in the step 420b, the T-register, S-register, and A-register are initialized to the values 0, B₀, and −s. The value B₀ is one of three coefficients utilized in the chebyshev filter. The value −s is the negation of the first half of the 36 bit sample fetched from a neighbor processing device. Next in the step 520c, the 36 bit multiplication is performed and the results stored in the T-register, S-register, and A-register are 0+, B₀, and (−s)⁺. In the step 520d, the T-register, S-register, and A-register are initialized to the values 0⁺, −S, and B₀ respectively, in preparation for the 35 bit multiplication. The value −S is the negation of the second half of the 36 bit sample fetched from a neighbor processing device respectively, in preparation for the 35 bit multiplication. Next in the step 520e, a 35 bit multiplication is performed and the results stored in the T-register, S-register, and A-register are 0⁺⁺, −S, and B₀⁺. Last in the step 520f, the NVM register A(n) is stored with the value A(n)+B₀⁺ and the NVM register A(n+1) is stored with the value A(n+1)+[(0⁺⁺xor −s) xor −s].

The fourth MAC in the step 530 of FIG. 5 is illustrated as follows. Returning to FIG. 5a, it begins in a step 520a by initializing the NVM A(m) and A(m+1) to the values A(m)′ and A(m+1)′. The value A(m)′ is the previous contents of the A(m) register and the value A(m+1)′ is the previous contents of the A(m+1) register. In the step 545 of FIG. 5 in the step 520b, the T-register, S-register, and A-register are initialized to the values 0, A₁″, and A(n)* respectively, in preparation for the 36 bit multiplication. The value A₁″ is the third of three coefficients utilized in the Chebyshev filter. The value A(n)* refers to the contents of the A(n) register after the MAC calculation of step 520. Next in the step 520c, the 36 bit multiplication is performed and the results stored in the T-register, S-register, and A-register are 0^{>}, A₁−, and (A(0)*)^{>}. In the step 520d, the T-register, S-register, and A-register are initialized to the values 0^{>}, A(n+1)*, and A₁″ respectively, in preparation for the 35 bit multiplication. In the step 520e, the 35 bit multiplication is performed and the results stored in the T-register, S-register, and A-register are 0^{>>}, A(n)*, (A₁″). Last in a step 520f, the NVM register A(m) is stored with the value [A(m)+A(n)*]+(A₁″)^{>} and the NVM register A(m+1) is stored with the value [A(m+1)+A(n+1)*]+[(0^{>>} xor A(n)*]xor A(n+1).

The value m is related to the value n in that they each refer to the first of two sequential registers used to store the results from the MAC calculation. The change from the reference of n to m in the NVM is a result of step 540 of FIG. 5. Assuming a single pass-through of the state machine in FIG. 5 and a first execution of step 545, each successive execution of steps 520, 530, 535, and 545 occur with switching between the notation n and m. Hence in the previous examples, any instance in which the notation n is used, m replaces n and any instance in which the notation m is used, n replaces m. Therefore, the use of n and m in the previous example is arbitrary as the contents of the NVM which are updated after each MAC is based on the alternate register that is selected in step 540.

Various modifications may be made to the invention without altering its value or scope. For example, while this invention has been described herein using the example of the particular computers 405, many or all of the inventive aspects are readily adaptable to other computer designs, other sorts of computer arrays, and the like.

Similarly, while the present invention has been described primarily herein in relation to use in a hearing aid, the signal processing methods and apparatus are usable in many array computers, the same principles and methods can be used, or modified for use, to accomplish other inter-device reconfigurations, such as in general digital signal processing as used in communications between a transmitter and a receiver whether wireless, electrical or optical transmission further including analysis of received communications and radio reflections.

While specific examples of the inventive computer arrays of FIG. 4 415, 420, 425, 430, 435, 440, 445, and 450 computers 405, paths 410 and associated apparatus, have been discussed herein, it is expected that there will be a great many applications for these which have not yet been envisioned. While the apparatus is illustrated with the use of a specific processor chip, it is apparent the invention may also be practiced with other processor chips having different numbers of computers 405 and paths 410. Indeed, it is one of the advantages of the present invention that the inventive methods and apparatus may be adapted to a great variety of uses.

All of the above are only some of the examples of available embodiments of the present invention. Those skilled in the art will readily observe that numerous other modifications and alterations may be made without departing from the spirit and scope of the invention.

Accordingly, the disclosure herein is not intended as limiting and the appended claims are to be interpreted as encompassing the entire scope of the invention.

### INDUSTRIAL APPLICABILITY

The inventive computer logic array signal processing inventive computer arrays of FIG. 4 415, 420, 425, 430, 435, 440, 445, and 450 computers 405, paths 410 and associated apparatus and signal processing methods illustrated in FIG. 5 and FIG. 5a are intended to be widely used in a great variety of communication applications including hearing aid systems. It is expected that they will be particularly useful in wireless applications where significant computing power and speed are required.

As discussed previously herein, the applicability of the present invention is such that the inputting information and instructions are greatly enhanced, both in speed and versatility. Also, communications between a computer array and other devices are enhanced according to the described method and means. Since the inventive computer FIG. 4 415, 420, 425, 430, 435, 440, 445, and 450 computers 405, paths 410 and associated apparatus and signal processing methods illustrated in FIG. 5 and FIG. 5a may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1. An earpiece comprising: a plurality of microphones for producing an electrical signal proportional to a received acoustic signal; and, a plurality of pre-amplifiers connected by means of a plurality of data and control paths to said plurality of microphones for increasing the amplitude of the electrical analog signal, an analog to digital converter connected to said plurality of preamplifiers; and, a digital signal processor connected to the output of said analog to digital converter; and, a digital to analog converter connected to the output of said signal processor; and; a speaker attached to the output of said digital to analog converter for producing a acoustic signal proportional to the output of said digital to analog converter.

2. An earpiece as in claim 1, wherein said preamplifiers are connected to said analog to digital converter by a plurality of variable attenuators also connected and controlled by said digital signal processor.

3. An earpiece as in claim 1, further comprising a post processing amplifier for increasing the strength of said digital signal processor connected to said digital to analog converter.

4. An earpiece as in claim 1, wherein said signal processor comprises a plurality of processing devices communicating with four neighboring processing devices over a single drop bus with no common bus on a single semiconductor chip.

5. An earpiece as in claim 4, wherein said signal processor divides the input into bands that are spread across the array of processing devices each of which separate the audio samples into predefined frequency ranges.

6. An earpiece as in claim 5, wherein said signal processor divides the input into eight bands.

7. An earpiece as in claim 6, wherein said signal processor comprises four processing devices for performing the band filtering for a particular frequency band.

8. An earpiece as in claim 4, wherein said signal processor comprises a second order Chebyshev filter.

9. An earpiece as in claim 8, wherein said signal processor processes multiple frequency bands and comprises a second order Chebyshev filter performed three times sequentially totaling a sixth order Chebyshev filter for each band.

10. An earpiece as in claim 8, wherein said signal processor the second order Chebyshev filter is divided into three categories bandpass, lowpass, and highpass.

11. A method for performing a band filtering operation with a multi processing device computer comprising the steps of, assigning a group of processing devices a particular band to process, and, verifying that a sample has been received by a first processing device, and if a sample has been received passing said sample to a second processing device, and, performing a multiply-accumulate (“MAC”) calculation on said sample, and, passing the results of said MAC calculation to a third processing device and storing the results in a first register, and, selecting an alternative register for storing the result of the MAC, and alternating between said first and said alternate register for establishing a bandpass result.

12. A method for performing a band filtering operation with a multi processing device computer as in claim 11, wherein there are additional MAC steps to total three MAC steps before an alternative register is chosen.

13. A method for performing a band filtering operation with a multi processing device computer as in claim 12, where there is a total of four MAC steps before the alternative register is chosen.

14. A method for performing a band filtering operation with a multi processing device computer as in claim 11, wherein each MAC unit updates the contents of two sequential registers in the non-volatile memory (“NVM”) of the processing device in which the calculation is being performed.

15. A method for performing a band filtering operation with a multi processing device computer as in claim 11, wherein each of the MAC calculations perform the same function, but the registers within the processing device whose values are utilized in the calculation of the MAC are initialized to different values for each MAC calculation.

16. A method for performing a band filtering operation with a multi processing device computer as in claim 11, wherein each MAC calculation is comprised of the steps of, initializing two sequential registers in the NVM, and further initializing registers utilized for the purpose of performing a multiplication, and, performing a multiplication, and, yet further initializing the registers utilized for the purpose of performing a multiplication of one less bit, performing a one less bit multiplication, and updating the two sequential registers in the NVM in the processing device in which the calculation is being performed with the combined results from said first and the second multiplications.

17. A method for performing a band filtering operation with a multi processing device computer as in claim 16, wherein said first multiplication is a 36 bit multiplication and said second multiplication is a 35 bit multiplication.
